(19) United States
(12) Patent Application Publication
(10) Pub. No.: US 2023/0032606 A1
(43) Pub. Date: Feb. 2, 2023

(54) SYSTEMS AND METHODS FOR ESTABLISHING AND CONTINUALLY IMPROVING SHORT-RANGE GEOLOCATION ACCURACY FOR ATTENDANCE VERIFICATION

(71) Applicant: GirlCode, LLC, Traverse City, MI (US)

(72) Inventors: Jodie Schanhals, Traverse City, MI (US); Ron Somerville, Traverse City, MI (US)

(21) Appl. No.: 17/875,769

(22) Filed: Jul. 28, 2022

Related U.S. Application Data
(60) Provisional application No. 63/227,486, filed on Jul. 30, 2021.

(51) Int. Cl. G06Q 30/02; H04W 4/021

(52) U.S. Cl. CPC G06Q 30/0201; H04W 4/021

(57) ABSTRACT

An event verification application for accurately assessing geolocation data for users of the application to establish, record, and report attendance at those events for compliance, personal, or other use.

### INCORPORATION BY REFERENCE

This application claims the priority benefit of U.S. Provisional Patent Application Ser. No. 63/227,486, filed Jul. 30, 2021, the contents of which are herein incorporated by reference in their entirety.

### INCORPORATION BY REFERENCE

All publications and patent applications mentioned in this specification are herein incorporated by reference in their entirety, as if each individual publication or patent application was specifically and individually indicated to be incorporated by reference in its entirety.

### TECHNICAL FIELD

This disclosure relates generally to the field of geolocation and more specifically to the field of geolocation for the purpose of user attendance verification. Described herein are systems and methods for establishing and improving short-range geolocation accuracy for attendance verification.

### BACKGROUND

Currently available methods for court-required attendance verification include completing one or more paper forms signed by one or more representatives of an event (e.g., counseling, 12-step meeting, drug testing, community service, etc.). This paper-based system is prone to human error, loss, forging, privacy violations, and an administrative burden. Further, as described herein, tracking a substantially stationary object over time with conventional sensor modalities has proven to be inaccurate, often missing the actual mark by 10 to 30 meters. Accordingly, what is needed are techniques which remove these shortcomings of conventional system, while providing a more accurate and reliable method of attendance verification and object tracking.

### SUMMARY

In some aspects, the techniques described herein relate to a computer-implemented method of attendance verification, including: receiving meeting information for a meeting from one or more data sources, wherein the meeting information includes at least a meeting location, a date of the meeting, and a time of the meeting; receiving a location of a user computing device, wherein the location of the user computing device is timestamped; comparing the location of the user computing device with the meeting information from the one or more data sources to determine whether a first radius associated with the location of the user computing device intersects with a second radius associated with the meeting location; sampling, at a plurality of times during a duration of the meeting, the location of the user computing device; and determining an attendance score for the user computing device, the attendance score being based on determining whether any two or more consecutive user computing device location samples are outside the second radius.

In some aspects, the techniques described herein relate to a computer-implemented method, further including identifying the attendance score as positive if no two or more consecutive user computing device location samples are determined to be outside the second radius; and identifying the attendance score as negative if two or more consecutive user computing device location samples are determined to be outside the second radius.

In some aspects, the techniques described herein relate to a computer-implemented method, wherein the meeting location includes a latitude, a longitude, and a margin of error. In some aspects, the techniques described herein relate to a computer-implemented method, wherein the comparing further includes comparing one or more of parameters including: the timestamped location of the user computing device to the date of the meeting and the time of the meeting; the timestamped location of the user computing device to a start time of the meeting; a latitude of the user computing device to a latitude associated with the meeting location; or a longitude of the user computing device to a longitude associated with the meeting location.

In some aspects, the techniques described herein relate to a computer-implemented method, wherein when one or more of the parameters are within a threshold value, causing output of an indication to the user computing device that the meeting is valid to attend.

In some aspects, the techniques described herein relate to a computer-implemented method, wherein the meeting location is further associated with a warning radius, such that the method further includes causing output of a warning to the user computing device when the location of the user computing device is determined to be within the warning radius.

In some aspects, the techniques described herein relate to a computer-implemented method, further including receiving an indication from the user computing device that indicates that the user is still in the meeting; and updating the second radius based at least on the indication from the user computing device.

In some aspects, the techniques described herein relate to a computer-implemented method, further including updating the warning radius based on the updated second radius. In some aspects, the techniques described herein relate to a computer-implemented method, wherein the meeting location is further associated with an exit radius, such that the method further includes indicating that the user computing device has left the meeting location when the location of the user computing device intersects with the exit radius, the exit radius being within the second radius.

In some aspects, the techniques described herein relate to a non-transitory computer-readable storage medium for use in conjunction with a computing system, the computer-readable storage medium being configured to store executable program instructions that, when executed by the computing system, cause the computing system to perform operations including: receiving meeting information for a meeting from one or more data sources, wherein the meeting information includes at least a meeting location, a date of the meeting, and a time of the meeting; receiving a location of a user computing device, wherein the location of the user computing device is timestamped; comparing the location of the user computing device with the meeting information from the one or more data sources to determine whether a first radius associated with the location of the user computing device intersects with a second radius associated with the meeting location; sampling, at a plurality of times during a duration of the meeting, the location of the user computing device; and determining an attendance score for the user computing device, the attendance score being based on determining whether any two or more consecutive user computing device location samples are outside the second radius.

In some aspects, the techniques described herein relate to a non-transitory computer-readable storage medium, wherein the meeting location includes a latitude, a longitude, and a margin of error.

In some aspects, the techniques described herein relate to a non-transitory computer-readable storage medium, wherein the operations further include identifying the attendance score as positive when no two or more consecutive user computing device location samples are determined to be outside the second radius; and identifying the attendance score as negative when two or more consecutive user computing device location samples are determined to be outside the second radius. In some aspects, the techniques described herein relate to a non-transitory computer-readable storage medium, wherein the comparing further includes comparing one or more of parameters including: the timestamped location of the user computing device to the date of the meeting and the time of the meeting; the timestamped location of the user computing device to a start time of the meeting; a latitude of the user computing device to a latitude associated with the meeting location; or a longitude of the user computing device to a longitude associated with the meeting location.

In some aspects, the techniques described herein relate to a non-transitory computer-readable storage medium, wherein when one or more of the parameters are within a threshold value, causing output of an indication to the user computing device that the meeting is valid to attend.

In some aspects, the techniques described herein relate to a non-transitory computer-readable storage medium, wherein the meeting location is further associated with a warning radius, such that the operations further comprise causing output 15, wherein the operations further include: receiving an indication from the user computing device that indicates that the user is still in the meeting; and updating the second radius based at least on the indication from the user computing device.

In some aspects, the techniques described herein relate to a non-transitory computer-readable storage medium, wherein the operations further include updating the warning radius based on the updated second radius.

In some aspects, the techniques described herein relate to a non-transitory computer-readable storage medium, wherein the meeting location is further associated with an exit radius, such that the operations further include indicating that the user computing device has left the meeting location when the location of the user computing device intersects with the exit radius, the exit radius being within the second radius.

In some aspects, the techniques described herein relate to a system configured to verify attendance at a meeting, the system including: at least one a processor, communicatively coupled to a user computing device and memory, configured to store program instructions that, when executed by the at least one processor, cause the system to perform operations including: receiving meeting information for a meeting from one or more data sources, wherein the meeting information includes at least a meeting location, a date of the meeting, and a time of the meeting; receiving a location of a user computing device, wherein the location of the user computing device is timestamped; comparing the location of the user computing device with the meeting information from the one or more data sources to determine whether a first radius associated with the location of the user computing device intersects with a second radius associated with the meeting location; sampling, at a plurality of times during a duration of the meeting, the location of the user computing device; and determining an attendance score for the user computing device, the attendance score being based on determining whether any two or more consecutive user computing device location samples are outside the second radius.

In some aspects, the techniques described herein relate to a system, wherein the operations further include: receiving a second location of a second user computing device; comparing the second location of the second user computing device to the location of the user computing device; determining whether the second location is within a predetermined range of the location of the user computing device; and updating the meeting location when the second location of the second user computing device is within the predetermined range of the location of the user computing device.

In some aspects, the techniques described herein relate to a system, wherein the operations further include receiving location data from a plurality of user computing devices; removing one or more outliers from the location data; and calculating a new meeting location based on the location data from the plurality of user computing devices.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates an example embodiment of a system utilizing attendance verification.

FIG. 2 illustrates an example embodiment of a user successfully attending a meeting.

FIG. 3 illustrates an example embodiment of a user considered to have prematurely left a meeting.

FIG. 4 illustrates an example embodiment of improving a meeting's location and range based on previous meeting data.

FIG. 5 illustrates an example embodiment of using device locations from a plurality of users to improve a location and a range for a meeting.

FIG. 6 illustrates an example of how a user is represented in the system of FIG. 1.

FIG. 7 illustrates an example of how a meeting is represented in the system of FIG. 1.

FIG. 8 illustrates an example of how a meeting is modified when a user is determined to be outside the warning radius.

FIG. 9 is a flow chart of an example process for determining an attendance score corresponding to a meeting associated with a computing device. The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated systems or methods. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure. The systems and methods described herein may provide an event verification application for accurately assessing geolocation data to establish, record, and report attendance at an event. The geolocation data may be assessed by the application, stored for future use, and/or otherwise used by the application (and users and/or providers of the application) to establish attendance compliance.

In some embodiments, the present disclosure is directed to attendance verification. For example, attendance may be verified for court-ordered events (e.g., community service, counseling sessions, sobriety programs, etc.), continuing education events (e.g., continuing medical education, continuing legal education, etc.), workplaces, remote work, school attendance, event attendance, etc., or may even be used to track a location of an animal over time with respect to one or more pre-determined radii.

In one example embodiment, the systems and methods described herein are generally directed to the verification of attendance by probationers/clients at court-ordered events. In some embodiments, the systems and methods described herein may provide an application on a mobile device, computing device, a smart watch, or the like, to provide a user (e.g., probationer, student, physician, etc.) of the application the ability to check into an event, and have their location monitored for the duration of the event. The monitored location may be a user location associated with a mobile computing device running an application session that may be used to monitor and track the device location to within a few meters of accuracy. In some embodiments, the systems and methods may employ techniques to maintain and improve geolocation accuracy as users engage with the application and move about between meeting locations, for example.

In general, the systems and methods described herein solve a technical problem of determining and verifying a device location such that the location accurately represents a location of a user associated with the device. Such accurate verification may provide an advantage of determining a user/device location over time to avoid erroneously misrepresenting attendance of the user/device at an event. In some embodiments, the advantage of verifying such accuracy may be performed to avoid device-dependent shortcomings with respect to sensors, signal detection, and the like. For example, the systems and methods described herein may enable a method to determine and verify a device location over time by sampling device locations over time and employing a perimeter/radius-based assessment that may allow for a margin of error depending on a device-specific ability or lack thereof. That is, because location-based sensing for computing devices can vary, the systems and methods may utilize a radius distance (e.g., an outward circular distance with a maximum distance equal to the radius of a predefined size of a circle) to represent a location of a device/user.

The systems and methods may also utilize a similar radius distance for a location associated with an event. A margin of error for a particular device type may be configured to ensure the radius is large enough to track the device near to and far from the event location by enabling tracking based on overlapping circles associated with the user/device and the event. The selected size of the radius of the circle may provide for a margin of error which may be specific to each user/device, due to user device quality. For example, a Samsung® mobile device may have a Global Navigation Satellite System (GNSS) accuracy of about 1.9 meters while an iPhone® mobile device may have a GNSS accuracy of about 22 meters. Accuracy may be based on the manufacturer, device age, device components (e.g., dual frequency antennas plus or minus a Galileo satellite system), etc. Further, various mobile devices may undervalue or overvalue their accuracy. For example, a Samsung® mobile device undervalues its accuracy by about 67% while an iPhone® mobile device overvalues its accuracy by about 450%. Further still, the location tracking technologies described herein may provide higher precision when moving compared to when stationary. For example, when moving, the number of connected satellites is higher, leading to increased precision. Still further, location accuracy for mobile devices increases when a path taken by the device includes a turn or is substantially long. Conversely, when still, the GPS drift effect disrupts the signal because of environmental factors like buildings, trees, and weather conditions. Accordingly, the embodiments described herein improve upon location accuracy when a user computing device is substantially stationary or within a small radius, potentially within an error range of the location systems of the user computing device.

This approach is unique in how technology is used to determine a short-range, substantially stationary location over a period of time to verify a user's ongoing presence (e.g., pertaining to a device location) at an event, as opposed to conventional geolocation goals of tracking significant movement or pinpointing a user for single moments in time. The systems and methods described herein combine a variety of techniques to assess a short-range device location over an extended time period. In some embodiments, the systems and methods described herein also utilize an aggregate of historical geolocation data over time to create a crowdfence to continuously improve the accuracy of actual meeting locations.

Many factors prevent accurate geolocation results, including but not limited to: differences between a location's street address latitude and longitude and the actual meeting location (e.g., interior to the building); data inaccuracies of a location's latitude and longitude; physical obstructions, both inside and outside of the location's building; insufficient GPS input; incorrect third-party location data; or when a specific meeting has relocated. To address these barriers to accurate results, the systems and methods described herein use a combination of methods to determine a more accurate location, hereinafter referred to as “crowdfencing.”

As used herein, “crowdfencing” refers to one or more software algorithms used by the systems or methods described herein to determine and/or verify a location of a device associated with a user over time. The software algorithms may use data from one or more mobile computing device embedded sensors, (e.g., GPS, Bluetooth, accelerometer, compass, radio frequency, etc.) to assess a short-range device location over an extended time period.

In some embodiments, the term “meeting data source” refers to a private database residing on an Internet-accessible computing device (e.g., a networked server, a Cloud server, or a combination of both). Meeting information may be received from one or more databases or sources, including but not limited to: APIs, email, calendar applications, external lists, and/or meetings otherwise created by users with or without a computing device. In some embodiments, “meeting data source” refers to, for example, community service, counseling sessions, fellowship groups, various programs, etc. that may not be represented in a computing system or a connected database and that is instead manually added or created in a computing system communicatively connected to a tracked device.

In general, a location determination may be performed using any one or more of the following technologies: GPS location, Bluetooth near field communication, radio-frequency (RF) communications, accelerometer-based analysis, inertial measurement unit (IMU)-based analysis compass-based analysis, and crowdfencing-based analysis.

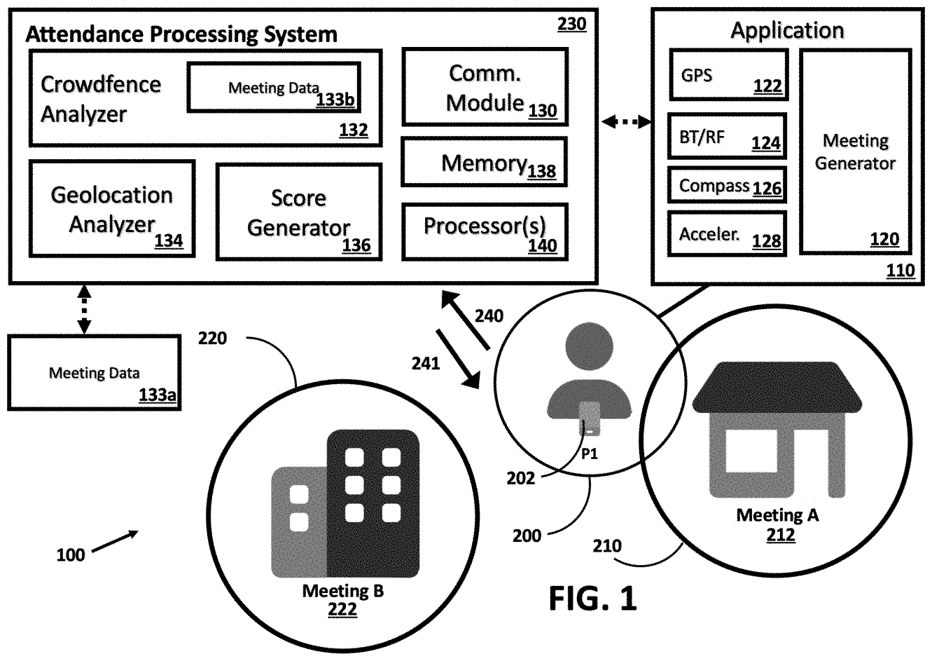

FIG. 1 shows an example embodiment of a system 100 utilizing attendance verification techniques described herein. As shown, the system 100 includes a user associated with a location 200 (e.g., a circle with a predefined radius) and a user device 202. The user device 202 may be in direct and/or indirect communication with a computing system (represented here as an attendance processing system 230) external to device 202. In some embodiments, the system 230 may provide functionality of an application 110 executing on device 202. In some embodiments, the system 230 may provide functionality of the application 110 via a service, a third-party service, or as an account-based accessible application.

The user device 202 may include at least the application 110 executed by one or more processors (not shown) using memory (not shown) available on device 202. For example, the application 110 may execute on device 202 and provide a graphical user interface (not show) of the application 110 executing on the user device 202. The application 110 may receive notice of and store information for one or more meetings. The information may include meeting details (e.g., dates, times, locations, etc.) which may include any or all data stored in meeting data 133a, 133b. The application 110 may also include a meeting generator 120. The meeting generator 120 may allow a device user to manually generate meetings for use with system 100.

The application may have access to any number of sensors including, but not limited to a global positioning system (GPS) sensor 122, a Bluetooth/RF sensor 124, a compass 126, and/or accelerometer-based sensor 128. Such sensors may be used by device 202 to determine a location (e.g., a geolocation) of device 202 and provide such locations and/or associated data to system 230. The provision of locations and/or associated data may be provided by device 202 in response to a prompt from system 230 received any number of times before, during, and/or after a scheduled meeting. In some embodiments, the provision of locations and/or associated data may be provided by device 202 to system 230 automatically and for any number of times before, during, and/or after a scheduled meeting.

In operation, system 100 may cause the application 110 to determine a geolocation of device 202, using one or more of the technologies listed above. The trigger for determining the geolocation of device 202 may include the device 202 receiving a call, a message, an execution request, or other indication corresponding to a meeting scheduled for the user of device 202. In response to the trigger, the system 202 may retrieve its geolocation and/or may provide the geolocation to system 230 (e.g., a server or other remote computing system). For example, in response to the trigger (e.g., call, message, execution request, indication, or the like), the system 230 may respond with or transmit available location data associated with device 202. The user of device 202 may select a meeting from within the GUI of the application 110 and may enter to attend the meeting. In some embodiments, the user of device 202 may alternatively generate a meeting location using a device geolocation obtained at the time of meeting generation.

While in the meeting, the application 110 monitors the location of device 202 periodically to ensure the device 202 (and the associated device user) is within the established crowdfence for the meeting. When the user leaves the meeting, a historical record is created and stored on device 202 and/or on system 230. This meeting is collected with additional meetings attended by the user in a determined time period and transmitted to one more predetermined contacts associated with the meeting, the device 202, and/or the system 230. In some embodiments, the predetermined contacts may represent the device 202 user's preferred contacts. For example, preferred contacts may include, but are not limited to, a probation officer, a supervisor, a board (e.g., continuing medical education board, continuing legal education board, etc.), a colleague, a family member, a friend, etc.

In some embodiments, limited meeting information is stored locally on the device 202 so that the application 110 may function without an Internet connection.

In some embodiments, the user device 202 may include a communication module (not shown) to communicate with system 230 via communication module 130. In some implementations, the device 202 may include any number of sensors, apps (not shown), displays (not shown), or the like to function with system 230 and application 110.

Referring again to FIG. 1, the attendance processing system 230 includes a crowdfence analyzer 132, a geolocation analyzer 134, and a score generator 136. Each of the crowdfence analyzer 132, the geolocation analyzer 134, and the score generator 136 may utilize communication module 130, memory 138, and processors 140. In short, the crowdfence analyzer 132, the geolocation analyzer 134, and the score generator 136 may function together to determine and/or verify location-based attendance for a user utilizing device 202.

The crowdfence analyzer 132 may include a plurality of programming instructions stored in memory (e.g., memory 138) and carried out by at least one processor (e.g., processor(s) 140) to utilize meeting data 133a, 133b and determine and/or verify a location of a device associated with a user over time. The crowdfence analyzer 132 may use data from one or more mobile computing device embedded sensors, (e.g., GPS, Bluetooth, accelerometer, compass, radio frequency, etc.) to assess a short-range device location over an extended time period. For example, the crowdfence analyzer 132 may determine device locations for any number of devices using signals and/or data received from sensors such as GPS 122, BT/RF sensor 124, compass 126, and/or accelerometer 128 for each respective device. Such sensor data may be automatically provided to system 230 and analyzer 132 or may be polled to request application 110 of any number of devices to provide location-based data information.

The crowdfence analyzer 132 may include meeting data 133b representing a meeting data source which may have been generated by system 230 when an associated meeting is scheduled. In some embodiments, the crowdfence analyzer 132 may instead receive meeting data 133a from another external source. In some embodiments, the meeting data 133a may be received by system 230 and stored as meeting data 133b.

The meeting data 133a and meeting data 133b may represent a source of meeting information. The data 133a, 133b may include at least a latitude (MA), a longitude (MO), and a margin of error (ME) value in degree units for each meeting location associated with a scheduled meeting. In some embodiments, the margin of error value may be stored with the data 133a, 133b.

The geolocation analyzer 134 may include a plurality of programming instructions stored in memory (e.g., memory 138) and carried out by at least one processor (e.g., processor(s) 140) to determine and/or generate geolocation data for a user associated with a computing device, such as user device 202. The geolocation may define a user profile for a designated geographic area (e.g., one or more meeting locations). The geolocation may include actual GPS location data and/or geolocation-specific data relative to one or more reference locations.

The score generator 136 may include a plurality of programming instructions stored in memory (e.g., memory 138) and carried out by at least one processor (e.g., processor(s) 140) to determine attendance scores for users associated with a computing device, such as user device 202. The score generator 136 may utilize sensor data, geolocation data, meeting information, or other system 100 data to generate scores for users.

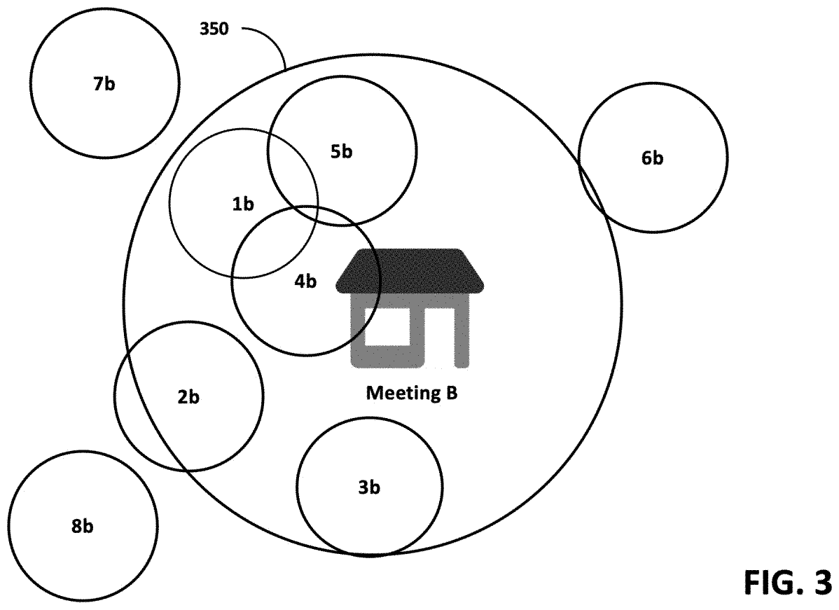

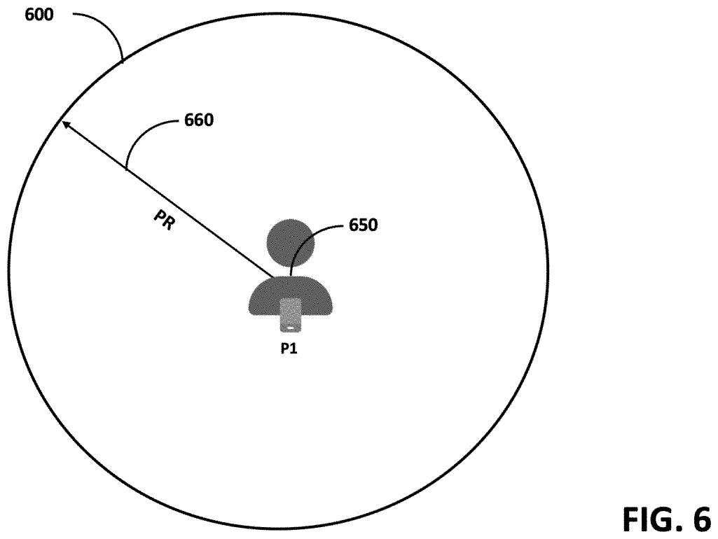

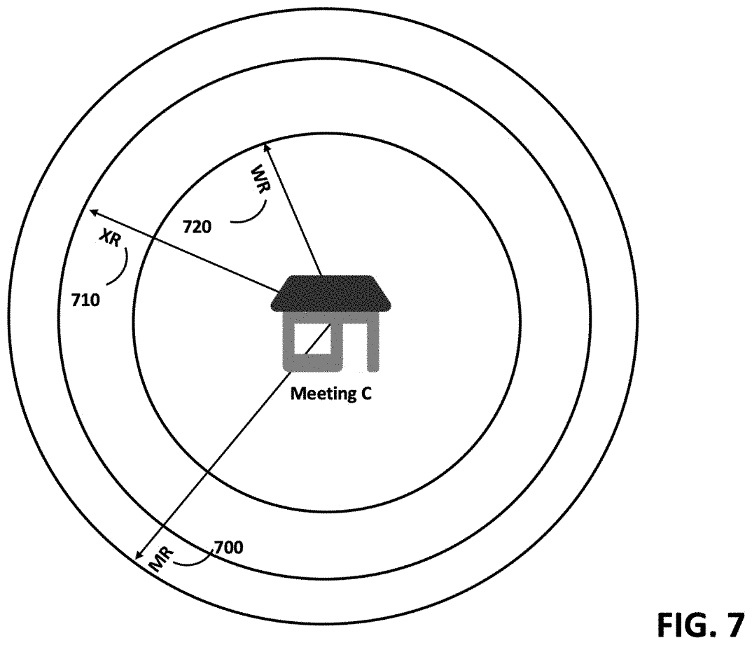

In a non-limiting example, verifying attendance for a user (and associated device) at a particular meeting may include receiving a user device location (e.g., location 200) and comparing the user device location with a meeting location (e.g., circle/location 220) obtained from a meeting data source (e.g., system 230 or another computing system or user device). As shown in FIG. 1, the location 200 of user P1 (and associated device 202) is represented by a circle, as will be described in FIG. 6. This location is sent to the system 230 where the meeting data source (e.g. meeting data 133a) is checked for valid meetings as described elsewhere herein. In this example (FIG. 1), there are two meetings, meeting A 212 and meeting B 222, which are represented as locations using circles 210, 220, respectively, as will be described in FIG. 7. In the example of FIG. 1, the user may be defined by location 200 and may join Meeting A 212, which may be indicated by the intersection of circle 200 and circle 210. In contrast, the user, defined by location 200, may be unable to join Meeting B 222 because circle 200 does not intersect with circle 220. When a user joins a meeting, the system 230 may set the user's device (e.g., device 202) location as the meeting location to which the user joined (e.g., Meeting A 212), which is then used to monitor this user's attendance as shown in FIGS. 3A and 3B.

In some embodiments, a calculation is performed by the system 230 to determine if the user is close enough (within a predefined threshold distance) to a location associated with a meeting to attend the meeting. For example, a location is retrieved from a user device 202 (e.g., mobile computing device, wearable device, laptop, tablet, or the like). The location may include a latitude (UA) and a longitude (UO) in degree units as well as the date and time (UD). All meeting data sources will have a latitude (MA), longitude (MO), and margin of error (ME) value in degree units. The margin of error value may be in the data source (e.g., meeting data 133a) or may be given a default value of about 0.0003 degrees (which is about 33 meters). This margin of error will be modified over time using crowdfencing, as described elsewhere herein.

In some embodiments, the ME value will increase if a particular meeting is manually created by a user/device using meeting generator 120. For example, when a user attends a meeting, a location of the user's computing device is received. In this case, the location of the user's computing device is outside of the meeting's location plus the ME value (e.g., because the meeting location is an auditorium or other large space or in an office building with many small offices). Because the user is attending the meeting, but the location of the user's computing device is determined to be outside of the meeting plus the ME value, a new meeting is created by the user so that the user can receive credit for attending this meeting. A remote computing device (e.g., system 230) is configured to compare the new meeting's location, time, name, etc. (provided by the user) to existing meeting locations to identify whether there are matches. In this case, the new meeting location may be matched to the existing meeting location. In such an example, the ME value of the existing meeting may be increased so that the next time a location of a user's computing device is detected at this same location, the user's computing device will be determined to be within the existing meeting's location plus the ME value range and the existing meeting will be presented to the user. In this fashion, the system 100 may provide an advantage of configuring a margin of error for location to ensure that system-generated margins of error do not penalize the user of the application 110 because a meeting location spans a larger than expected area (based on preprogrammed margins of error) by the application 110.

In some embodiments, the ME value may be decreased if the users attending the meeting all have UA and UO locations within a smaller range. For example, given a meeting with an initial range or ME value of 33 meters, if all attendees' device locations appear within a radius of 25 meters, the range of this meeting (the observed meeting) would be changed to 110% of the observed meeting range (i.e., 25 meters) or 27.5 meters.

This flexible margin of error for specific meetings will account for locations with various GPS signal quality (due to no physical obstructions versus significant obstructions). For example, in some embodiments, one or more meeting characteristics are stored with each meeting data 133a, which may be provided with the meeting generated by the meeting generator 120. Exemplary, non-limiting examples of meeting characteristics include: name, day of the week, start time, end time, frequency (weekly, monthly, etc.), location, ME value, etc. Also, this margin of error will account for room size, for example a single person office versus an auditorium. The system 230 then searches the meeting data sources (e.g., meeting data 133a and/or meeting data 133b) for any meetings that match the following criteria that the user can attend. (1) The meeting occurs on the same day of week as UD. (2) The meeting is indicated to begin within a range of 1 hour before UD and 1 hour after UD. (3) The following formula for latitude is true: MA−ME≤UA≤MA+ME. (4) The following formula for longitude is true: MO−ME≤UO≤MO+ME, where MA is meeting latitude, ME is margin of error, and MO is meeting longitude. In some embodiments, any stored meetings that match all four criteria are presented to the user as valid meetings that they can attend. Alternatively, or additionally, any meetings matching one or more, two or more, three or more, at least two, at least three, etc. criteria are presented to the user as valid to attend. The available meetings may also be ranked depending on how many criteria are met.

The communication module 130 of system 230 may include one or more devices for communicating with device 202, other computing devices, mobile devices, and/or systems configured to receive communications from the system 230. The communication module 130 may communicate via wireless or wired networks.

The processors 140 may include one or more processors that include one or more devices capable of executing computer readable instructions, such as instructions stored by the memory 138, crowdfence analyzer 132, geolocation analyzer 134, and/or score generator 136, to perform various tasks associated with determining a geolocation and attendance score for device 202 (or another computing device communicatively coupled to system 230). In addition, the processors 140 may include one or more processors that include one or more devices capable of executing computer readable instructions, to receive communications from sensors 122-128 and/or meeting generator 120.

The memory 138 can include one or more non-transitory computer-readable storage media. The memory 138 may store instructions and data that are usable in combination with processors 140 to trigger execution of application 110 and/or communication with device 202. The memory 138 may also function to store or have access to application data from application 110 and/or events or meetings stored and/or generated by meeting generator 120.

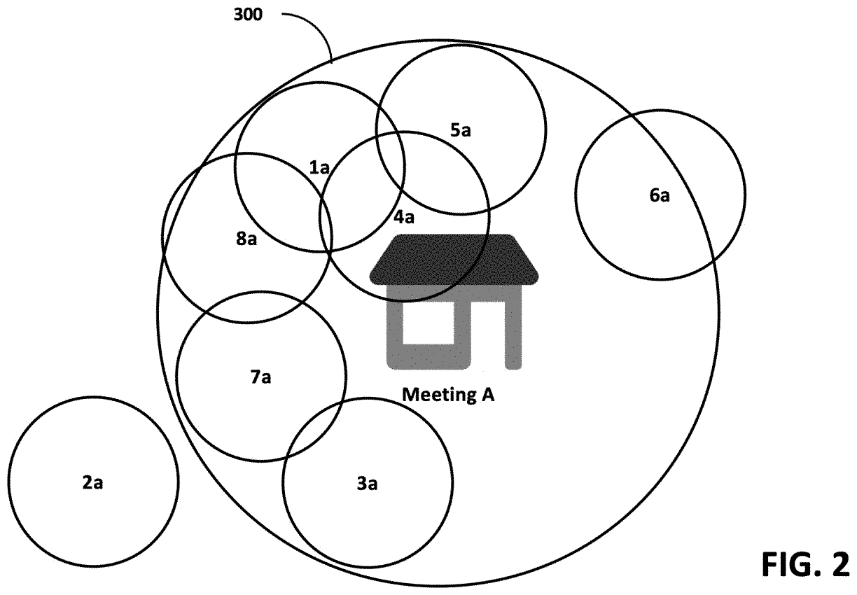

As shown in FIG. 2, an example embodiment of successfully attending a meeting includes monitoring a user device locations as described elsewhere herein and confirming that the user device is within an expected meeting radius 300. FIG. 2 shows a meeting with a radius 300, which is described in further detail in FIG. 7, as well as acquired location samples for a number of locations (captured over time) where each location is associated with a user device “a.” Each location of device “a” is labeled in ascending order to indicate consecutively captured location samples, as shown in FIG. 2 as location radii 1a, 2a, 3a, 4a, 5a, 6a, 7a and 8a. In general, consecutively captured location samples may be defined as samples that are captured in time order, but the times between each captured sample may vary.

In operation, the system 230 may receive meeting information for a meeting associated with meeting radius 300. The system 230 may receive an initial location of the device “a” to determine if the device is within a range of a location (e.g., radius 300) associated with meeting A. The system 230 may then receive locations sampled over time for device “a,” shown here as location samples 1a-8a. The system 230 may compare the received locations 1a-8a with the received meeting information (e.g., meeting data 133a and/or 133b) to determine whether a respective radius (of a circle) associated with each location 1a-8a intersects with the meeting radius 300. The system 230 may determine an attendance score for the device “a” based on determining whether any two or more consecutive user device location samples are outside of the meeting radius 300. The attendance score may be a positive or negative indicator or an actual score for a portion of the meeting being attended. In some embodiments, the attendance score may be a positive notation (e.g., “+” or pass) indicating that the user attended the meeting or may be a negative notation (e.g., “−” or fail) indicating that the user did not attend the meeting or did not attend a portion of the meeting. The score may be used to determine whether or not a user will receive credit for attending the meeting. In some embodiments, the score may provide a percentage of the meeting attended by using the sampled locations 1a-8a and their corresponding timestamps to figure out when the user was outside of the meeting radius 300.

In the example of FIG. 2, the meeting attendance is verified and considered successful since there are no two consecutive location samples 1a-8a that are outside the meeting radius 300. As shown, location sample 2a is outside the radius 300, but location samples 1a and 3a are within the radius, which may be considered acceptable for this particular meeting and by this system. It will be appreciated that the meeting attendance success criteria (and/or scoring protocol) may be different for each meeting.

FIG. 3 shows an example embodiment of a failed meeting attendance when a user device location is outside of or does not overlap with the expected meeting radius. To accommodate inconsistent location data for this example meeting, the system 230 may use two consecutive user locations outside the radius of the meeting as in indication of a failed attendance score. FIG. 3 shows a meeting B with a radius 350, as will be described in FIG. 7, as well as acquired location samples for a user device, shown here as location radii 1b-8b. Location radii 1b-8b represent a series of timestamped location samples. For example, samples may be captured every about 30 seconds for about 4 minutes to obtain radii 1b-8b. Although as one of skill in the art will appreciate, any frequency and/or time period of location sampling is contemplated by this disclosure. This example meeting attendance is considered unsuccessful because consecutive location samples 7b and 8b are both outside the meeting radius 350. It will be appreciated that the meeting attendance unsuccessful criteria (and/or scoring protocol) may be different for each meeting.

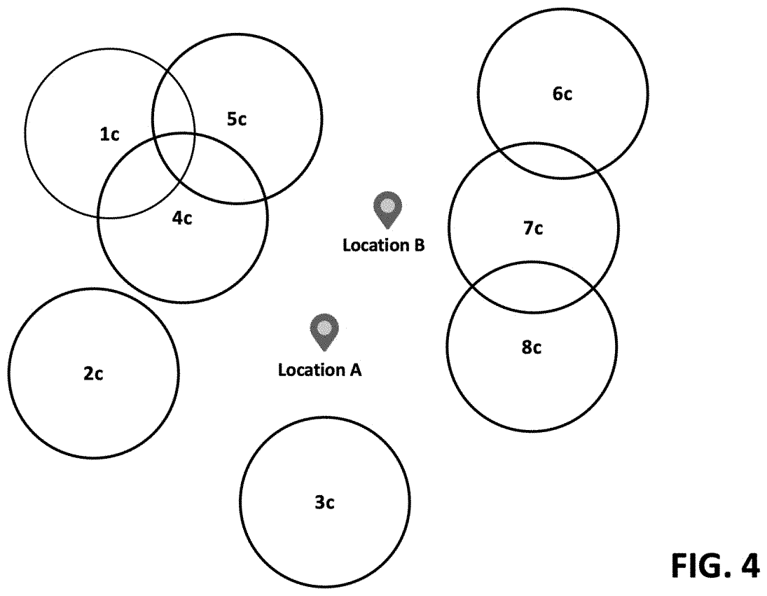

As shown in FIG. 4, one embodiment of improving a meeting location includes tracking a number of times a particular meeting and/or location has been attended. For a threshold value of meeting occurrences (e.g., every 8 meeting occurrences), the system 230 analyzes latitude and longitude data from a plurality of user location samples 1c-8c, removes one or more outliers (e.g., the top and bottom about 5%, about 1%, about 2%, about 10%, about 1% to about 5%, about 1% to about 10%, about 5% to about 10%, about 2% to about 7%, etc. of values) from the latitude and longitude data, and performs a statistical mean on the remaining values to set a new (e.g., updated, corrected, alternate, etc.) location for the analyzed meeting. FIG. 4 shows an initial meeting location (represented by Location A) and then eight examples of different users attending meeting A, represented by user location samples 1c-8c. Since the threshold value has been reached (in this example 8), the meeting location is updated via the method described (represented in FIG. 4 by Location B). As one of skill in the art will appreciate, although eight samples is suggested as a threshold, any number of samples is contemplated, for example 1-5, 1-10, 5-15, 10-20, 10-30, 10-100, 50-250, 10-500, etc.

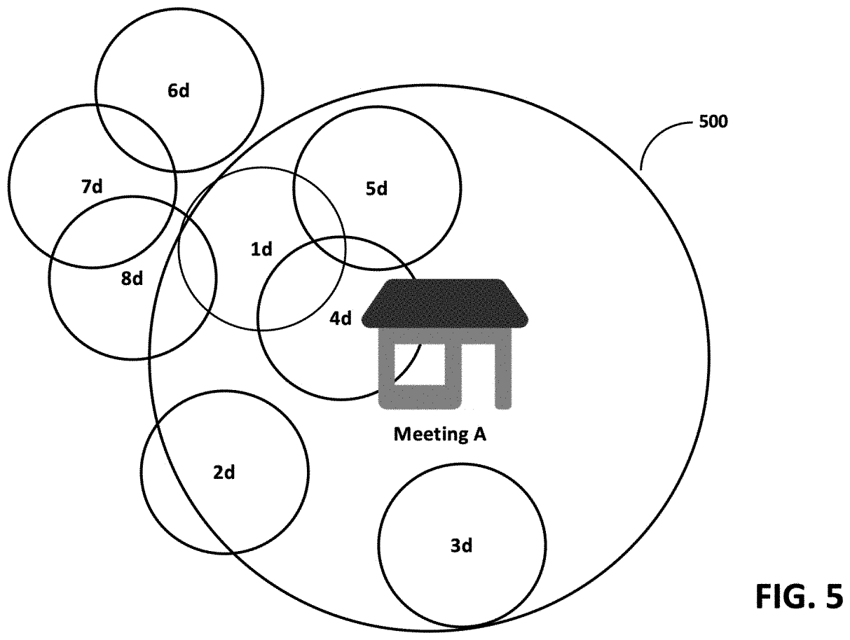

FIG. 5 shows one embodiment of multiple user location samples 1d-8d contributing to validation of a meeting location 500. This embodiment helps solve the problem of an inaccurate initial meeting location, as described above in relation to FIG. 4. FIG. 5 shows a radius of a meeting location, as described in FIG. 7, and eight attendees represented by radii of location samples 1d-8d, as described in FIG. 6. In this example, users 6d and 7d are both outside the meeting radius which would usually mean they are considered to have left the meeting. However, since users 6d, 7d are both within range (e.g., a near field communication radius) of another user 8d, users 6d, 7d are maintained in the meeting A. A specific meeting location of both users 6d, 7d is recalculated based on an average of the location samples 1d-8d taken for this meeting A, as described elsewhere herein.

As shown in FIG. 6, a location of a user is represented by a circle 600 with radius 660. A center 650 of the circle 600 is a reported location of a user. The radius 660 of the circle 600 represents a margin of error which may be specific to each user, due to user device quality. For example, a Samsung® mobile device may have a Global Navigation Satellite System (GNSS) accuracy of about 1.9 meters while an iPhone® mobile device may have a GNSS accuracy of about 22 meters. Accuracy may be based on the manufacturer, device age, device components (e.g., dual frequency antennas plus or minus a Galileo satellite system), etc. Further, various mobile devices may undervalue or overvalue their accuracy. For example, a Samsung® mobile device undervalues its accuracy by about 67% while an iPhone® mobile device overvalues its accuracy by about 450%. Further still and important for the technologies described herein, devices offer nearly 20% higher precision when moving compared to when stationary. For example, the number of connected satellites is higher, leading to better precision. Conversely, when still, the GPS drift effect disrupts the signal because of environmental factors like buildings, trees, and weather conditions. Accordingly, the embodiments described herein improve upon location accuracy when a user computing device is substantially stationary or within a small radius, potentially within an error range of the location systems of the user computing device. Still further, location accuracy for mobile devices increases when a path taken by the device includes a turn or is substantially long. For example, accuracy improved by about 67% when a larger path was taken. For Samsung® mobile devices, precision increased from 3-meter accuracy in the short path to 1-meter accuracy on the longer path. Longer paths seem to offer greater reliability and precision of GNSS signal. In contrast, the embodiments described herein improve upon location accuracy when a user computing device is substantially stationary or moves along a short path (e.g., within a radius of a meeting location).

As shown in FIG. 7, a meeting's location is represented by multiple circles around the initial meeting location. Radius 700 or MR represents an area where a user is to be located within to be counted by system 230 as joined to a meeting C. This range is wider to account for the possibility of inaccurate meeting locations, as described above in relation to FIG. 5. Radii 710, 720 or WR, XR, respectively, are used once a meeting has been joined. Radius 710 or WR is a warning radius that the user is to remain within to be considered attending the meeting properly. If the user is outside radius 710 or WR circle but within the XR circle or radius 720, the user is considered to be in the warning zone. A prompt will be transmitted to the user so that the user may confirm that they are still attending the meeting. If the user is outside the XR circle or radius 710, the user is considered to have left the meeting and will be made to exit the meeting. The XR radius 710 is configured to be within the meeting radius 710. The XR radius 710 is configured to provide a buffer zone to determine how much of the location/radius associated with the user device is outside of the XR (e.g., exit) radius 710. As data is collected from one or more users, the MR should become more accurate and approach the XR.

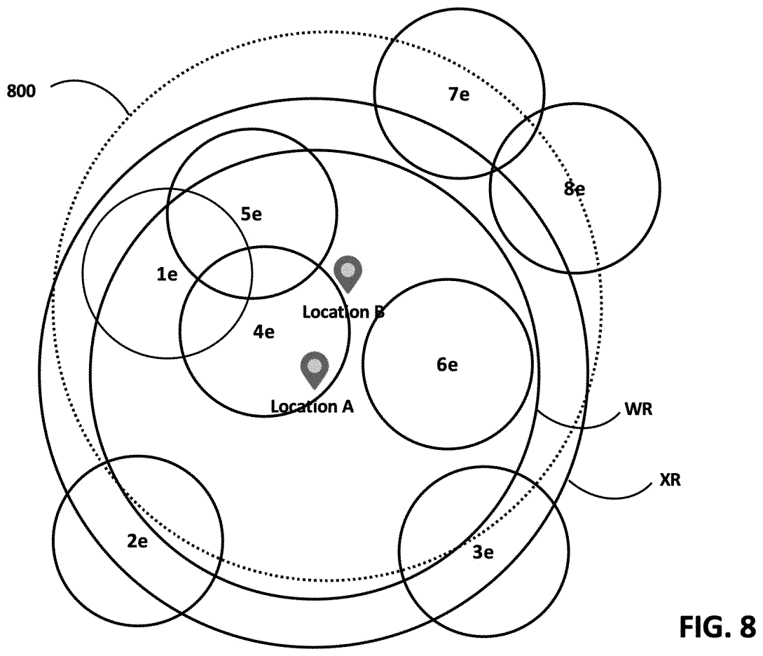

FIG. 8 illustrates an example embodiment of how a meeting is updated after the user receives a warning that they are approaching an out-of-range location. As shown, the initial meeting location is indicated as Location A with a circle WR representing the warning range and an XR circle representing the exit range. In some embodiments, the circle may instead be a triangle, a square, a rectangle, an ellipse, or other predefined shape. Eight sample locations 1e-8e are depicted to represent the user device in various sample locations. Since sample locations 7e and 8e are both outside the warning radius WR, the user will be prompted to indicate whether they are still attending the meeting. If the user confirms they are still in the meeting, the meeting location will be updated using an average of all of the location samples up to this point. In FIG. 8, the new meeting location is shown as Location B, with a dashed line 800 showing the new exit range of the meeting.

In some embodiments, the systems and methods described herein may also include an indicator of when a user switches between or from a first user computing device to a second computing device. In such embodiments, both devices may be tracked for a location or a device selected by the user as the main device may be tracked for a location.

In some embodiments, the system may be equipped to handle potential manipulation of location data. For example, 1) when the user is prompted to indicate whether they are still in the meeting, their response (yes, no) or lack of response is timestamped and added to the meeting record and/or 2) any reporting on a meeting will include the percentage of time the user was considered “away from the meeting” (outside the WR circle), with special attention brought to any meeting where the user was “away” more than, for example 30% of the meeting time. Although 30% was used, one of skill in the art will appreciate that this disclosure includes a range, for example away about 10% to about 30%, about 20% to about 40%, about 15% to about 35%, etc.

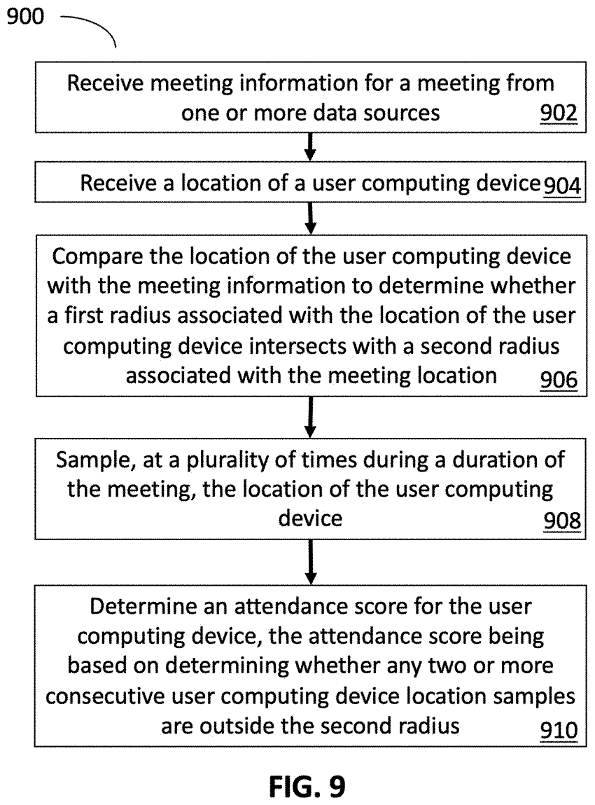

FIG. 9 is a flow chart of an example process 900 for determining an attendance score corresponding to a meeting associated with a computing device. The process 900 may be performed to assess and/or verify attendance of a user (using a user device 202, for example) at a scheduled meeting location. In some embodiments, the process 900 may be carried out on attendance processing system 230. The example below is described as being carried out by system 230, however, other computing systems may instead execute the process 900. For example, in some embodiments, the process 900 may instead be carried out by a third-party computing system. In some embodiments, the process 900 may instead be carried out locally on device 202 and provided to (or corroborated with/validated against data on) another computing device for attendance and/or data verification.

At block 902, the process 900 includes receiving meeting information for a meeting from one or more data sources. In general, the meeting information includes at least a meeting location, a date of the meeting, and a time of the meeting. For example, the system 230 may receive meeting information such as meeting data 133a that may include time, date, and location data (e.g., latitude, longitude, etc.) associated with the meeting. The meeting may be scheduled or awaiting scheduling. The time, data, and location may be stored in memory 138. In some embodiments, the meeting location includes a latitude, a longitude, and a margin of error.

At block 904, the process 900 includes receiving a location of a user computing device. The location of the user computing device is timestamped. The timestamps may be used by system 230 to determine how long a user device may be within (or outside of) a meeting location radius. The location may be provided by user device 202 and received by system 230. The location may function as an initial location for user device 202.

At block 906, the process 900 includes comparing the location of the user computing device with the meeting information from the one or more data sources to determine whether a first radius associated with the location of the user computing device intersects with a second radius associated with the meeting location. For example, the system 230 may receive and compare an initial location (the first radius of location sample 1a in FIG. 2) of the user device 202 (e.g., device “a” in FIG. 2) to the second radius associated with meeting information (e.g., meeting data 133a, 133b) to determine if the device 202 is within a range of a second radius (e.g., the meeting location radius 300 in FIG. 2). Determining that the location of the user computing device is within the second radius indicates that the user is attending the meeting associated with the meeting information.

In some embodiments, comparing the location of the user computing device with the meeting information from the one or more data sources includes comparing one or more of parameters such as comparing a timestamped location of the user computing device to a date of the meeting and a time of the meeting. In some embodiments, comparing the location of the user computing device with the meeting information from the one or more data sources includes comparing one or more of parameters such as comparing the timestamped location of the user computing device to a start time of the meeting. In some embodiments, comparing the location of the user computing device with the meeting information from the one or more data sources includes comparing one or more of parameters such as comparing a latitude of the user computing device to a latitude associated with the meeting location. In some embodiments, comparing the location of the user computing device with the meeting information from the one or more data sources includes comparing one or more of parameters such as comparing a longitude of the user computing device to a longitude associated with the meeting location. In general, if the comparison of the one or more of the parameters falls within a predefined threshold value, the system 230 may cause output of an indication to the user computing device that the meeting is valid to attend.

At block 908, the process 900 includes sampling, at a plurality of times during a duration of the meeting, the location of the user computing device. For example, the system 230 may receive locations sampled over time for the user device (e.g., device “a” in FIG. 2 depicted as location samples 1a-8a.) The system 230 may compare the received locations 1a-8a with the received meeting information (e.g., meeting data 133a and/or 133b) to determine whether a respective radius (of a circle) associated with each location 1a-8a intersects with the meeting radius 300.

In some embodiments, the meeting location is further associated with a warning radius, such that the process 900 may further include causing output of a warning to the user computing device when the location of the user computing device is determined to be within the warning radius.

In some embodiments, the system 230 may receive an indication from the user computing device 202 that indicates that the user is still in the meeting and in response to receiving such an indication, the system 230 may update the second radius (e.g., meeting radius 300) based at least on the indication from the user computing device. In addition, the system 230 may update the warning radius based on the updated second radius (e.g., meeting radius 300).

In some embodiments, the meeting location is further associated with an exit radius, such that the process 900 may further include indicating that the user computing device 202 has left the meeting location when the location of the user computing device 202 intersects with the exit radius. The exit radius may be located within the second radius (e.g., meeting radius 300).

At block 910, the process 900 includes determining an attendance score for the user computing device. The attendance score may be based on determining whether any two or more consecutive user computing device location samples are outside the second radius. For example, the system 230 may determine an attendance score for the device “a” based on determining whether any two or more consecutive user device location samples are outside of the meeting radius 300. The attendance score may be a positive or negative indicator or an actual score for a portion of the meeting being attended. In some embodiments, the attendance score may be a positive notation (e.g., “+” or pass) indicating that the user attended the meeting or may be a negative notation (e.g., “−” or fail) indicating that the user did not attend the meeting or did not attend a portion of the meeting. The score may be used to determine whether or not a user will receive credit for attending the meeting. In some embodiments, the score may provide a percentage of the meeting attended by using the sampled locations 1a-8a and their corresponding timestamps to figure out when the user was outside of the meeting radius 300.

In some embodiments, the attendance score may be identified as positive if no two or more consecutive user computing device location samples are determined to be outside the second radius (e.g., meeting radius 300). In some embodiments, the attendance score may be identified as negative if two or more consecutive user computing device location samples are determined to be outside the second radius (e.g., meeting radius 300).

In some embodiments, the process 900 may further include receiving a second location of a second user computing device, comparing the second location of the second user computing device to the location of the user computing device, determining whether the second location is within a predetermined range of the location of the user computing device, and updating the meeting location when the second location of the second user computing device is within the predetermined range of the location of the user computing device.

In general, the process 900 may be carried out on a computer program product (e.g., a computer-readable medium that is tangibly embodied in an information carrier). The computer program product may also contain instructions that, when executed, perform one or more methods and/or computer-implemented methods described herein (e.g., process 900). The information carrier may be a computer- or machine-readable medium, such as memory 138, or other storage and/or processors 140 associated with system 230, device 202, and/or system 100 as a whole.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor on a mobile computing device and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

As used in the description and claims, the singular form “a”, “an” and “the” include both singular and plural references unless the context clearly dictates otherwise. For example, the term “sample location” may include, and is contemplated to include, a plurality of sample locations. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method of attendance verification, comprising:
receiving meeting information for a meeting from one or more data sources, wherein the meeting information includes at least a meeting location, a date of the meeting, and a time of the meeting;
receiving a location of a user computing device, wherein the location of the user computing device is timestamped;
comparing the location of the user computing device with the meeting information from the one or more data sources to determine whether a first radius associated with the location of the user computing device intersects with a second radius associated with the meeting location;
sampling, at a plurality of times during a duration of the meeting, the location of the user computing device; and
determining an attendance score for the user computing device, the attendance score being based on determining whether any two or more consecutive user computing device location samples are outside the second radius.

2. The computer-implemented method of claim 1, further comprising:
identifying the attendance score as positive if no two or more consecutive user computing device location samples are determined to be outside the second radius; and
identifying the attendance score as negative if two or more consecutive user computing device location samples are determined to be outside the second radius.

3. The computer-implemented method of claim 1, wherein the meeting location comprises a latitude, a longitude, and a margin of error.

4. The computer-implemented method of claim 1, wherein the comparing further comprises comparing one or more of parameters comprising:
the timestamped location of the user computing device to the date of the meeting and the time of the meeting;
the timestamped location of the user computing device to a start time of the meeting;
a latitude of the user computing device to a latitude associated with the meeting location; or
a longitude of the user computing device to a longitude associated with the meeting location.

5. The computer-implemented method of claim 4, wherein when one or more of the parameters are within a threshold value, causing output of an indication to the user computing device that the meeting is valid to attend.

6. The computer-implemented method of claim 1, wherein the meeting location is further associated with a warning radius, such that the method further comprises causing output of a warning to the user computing device when the location of the user computing device is determined to be within the warning radius.

7. The computer-implemented method of claim 6, further comprising:
receiving an indication from the user computing device that indicates that the user is still in the meeting; and
updating the second radius based at least on the indication from the user computing device.

8. The computer-implemented method of claim 7, further comprising updating the warning radius based on the updated second radius.

9. The computer-implemented method of claim 1, wherein the meeting location is further associated with an exit radius, such that the method further comprises indicating that the user computing device has left the meeting location when the location of the user computing device intersects with the exit radius, the exit radius being within the second radius.

10. A non-transitory computer-readable storage medium for use in conjunction with a computing system, the computer-readable storage medium being configured to store executable program instructions that, when executed by the computing system, cause the computing system to perform operations comprising:
receiving meeting information for a meeting from one or more data sources, wherein the meeting information includes at least a meeting location, a date of the meeting, and a time of the meeting;
receiving a location of a user computing device, wherein the location of the user computing device is timestamped;
comparing the location of the user computing device with the meeting information from the one or more data sources to determine whether a first radius associated with the location of the user computing device intersects with a second radius associated with the meeting location;
sampling, at a plurality of times during a duration of the meeting, the location of the user computing device; and
determining an attendance score for the user computing device, the attendance score being based on determining whether any two or more consecutive user computing device location samples are outside the second radius.

11. The non-transitory computer-readable storage medium of claim 10, wherein the meeting location comprises a latitude, a longitude, and a margin of error.

12. The non-transitory computer-readable storage medium of claim 10, wherein the operations further comprise:
identifying the attendance score as positive when no two or more consecutive user computing device location samples are determined to be outside the second radius; and
identifying the attendance score as negative when two or more consecutive user computing device location samples are determined to be outside the second radius.

13. The non-transitory computer-readable storage medium of claim 10, wherein the comparing further comprises comparing one or more of parameters comprising:
the timestamped location of the user computing device to the date of the meeting and the time of the meeting;
the timestamped location of the user computing device to a start time of the meeting;
a latitude of the user computing device to a latitude associated with the meeting location; or
a longitude of the user computing device to a longitude associated with the meeting location.

14. The non-transitory computer-readable storage medium of claim 13, wherein when one or more of the parameters are within a threshold value, causing output of an indication to the user computing device that the meeting is valid to attend.

15. The non-transitory computer-readable storage medium of claim 10, wherein the meeting location is further associated with a warning radius, such that the operations further comprise causing output of a warning to the user computing device when the location of the user computing device is determined to be within the warning radius.

16. The non-transitory computer-readable storage medium of claim 15, wherein the operations further comprise:
receiving an indication from the user computing device that indicates that the user is still in the meeting; and
updating the second radius based at least on the indication from the user computing device.

17. The non-transitory computer-readable storage medium of claim 16, wherein the operations further comprise updating the warning radius based on the updated second radius.

18. The non-transitory computer-readable storage medium of claim 10, wherein the meeting location is further associated with an exit radius, such that the operations further comprise indicating that the user computing device has left the meeting location when the location of the user computing device intersects with the exit radius, the exit radius being within the second radius.

19. A system configured to verify attendance at a meeting, the system comprising: at least one a processor, communicatively coupled to a user computing device and
memory, configured to store program instructions that, when executed by the at least one processor, cause the system to perform operations comprising:
receiving meeting information for a meeting from one or more data sources, wherein the meeting information includes at least a meeting location, a date of the meeting, and a time of the meeting;
receiving a location of a user computing device, wherein the location of the user computing device is timestamped;
comparing the location of the user computing device with the meeting information from the one or more data sources to determine whether a first radius associated with the location of the user computing device intersects with a second radius associated with the meeting location;
sampling, at a plurality of times during a duration of the meeting, the location of the user computing device; and
determining an attendance score for the user computing device, the attendance score being based on determining whether any two or more consecutive user computing device location samples are outside the second radius.

20. The system of claim 19, wherein the operations further comprise:
receiving a second location of a second user computing device;
comparing the second location of the second user computing device to the location of the user computing device;
determining whether the second location is within a predetermined range of the location of the user computing device; and
updating the meeting location when the second location of the second user computing device is within the predetermined range of the location of the user computing device.

21. The system of claim 19, wherein the operations further comprise:
receiving location data from a plurality of user computing devices;
removing one or more outliers from the location data; and
calculating a new meeting location based on the location data from the plurality of user computing devices.
